(19) United States
(12) Patent Application Publication
(10) Pub. No.: US 2020/0180539 A1
(43) Pub. Date: Jun. 11, 2020

(54) VEHICLE SEAT ASSEMBLY FOR A MOTOR VEHICLE

(71) Applicant: Joyson Safety Systems Germany GmbH, Aschafferburg (DE)

(72) Inventor: Mirko KORTH, Ulm (DE)

(73) Assignee: Joyson Safety Systems Germany GmbH, Aschafferburg (DE)

(21) Appl. No.: 16/304,960

(22) PCT Filed: May 31, 2017
(86) PCT No.: PCT/EP2017/063138

§ 371 Date: Nov. 27, 2018

(30) Foreign Application Priority Data
Jun. 1, 2016 (DE) 10 2016 209 584.6

(51) Int. Cl. B60R 21/207; B60R 21/2342; B60R 21/237

(52) U.S. Cl. CPC B60R 21/207; B60R 2021/0048; B60R 21/237; B60R 21/2342

(57) ABSTRACT

A vehicle seat assembly for a motor vehicle comprising a vehicle seat and at least one inflatable gas bag arranged in a backrest of the vehicle seat for protecting at least the head of a vehicle occupant on the vehicle seat. The gas bag is arranged and configured in such a way that in the inflated state it extends under a seat cover of the vehicle seat from a lower region of the backrest to an upper region of the backrest and emerges from the vehicle seat in the upper region of the backrest.

This application is a National Phase patent application of International Patent Application Number PCT/EP2017/063138, filed on May 31, 2017, which claims priority of German Patent Application Number 10 2016 209 584.6, filed on Jun. 1, 2016.

### BACKGROUND

This invention relates to a vehicle seat assembly for a motor vehicle.

Such a vehicle seat assembly is known for example from DE 197 04 657 A1, which discloses a vehicle seat with an integrated gas bag that with one region is to protect the head of a vehicle occupant.

### SUMMARY

It is the problem underlying the present invention to provide for a stability as good as possible of a seat-integrated gas bag for the protection of the head of a vehicle occupant.

This problem is solved by providing the vehicle seat assembly with features as described herein.

Accordingly, there is provided a vehicle seat assembly for a motor vehicle, comprising
a vehicle seat; and
at least one inflatable gas bag arranged in a backrest of the vehicle seat for protecting at least the head of a vehicle occupant on the vehicle seat, wherein
the gas bag is arranged and configured in such a way that in the inflated state it extends from a lower region of the backrest to an upper region of the backrest under a seat cover of the vehicle seat and emerges from the vehicle seat in the upper region of the backrest.

The gas bag thus is deployed proceeding from the lower region of the backrest up to its upper region below the seat cover, so that a first portion of the inflated gas bag extends under the seat cover along as large a length as possible of the backrest. In particular due to the large contact surface with the vehicle seat compared to conventional side gas bags, this (e.g. oblong) first portion of the gas bag contributes to the stabilization of the position of a second portion (a protective portion) of the inflated gas bag extending outside the seat cover.

For example, the gas bag is designed such that it emerges from the vehicle seat exclusively from the upper region of the backrest, i.e. as a protective portion the gas bag exclusively includes a region that serves to protect the head of the vehicle occupant and correspondingly extends at the level of the head. In this exemplary embodiment, the gas bag thus continuously extends below the seat cover from the lower region to the upper region of the backrest. It is conceivable that the gas bag has merely one chamber, wherein the above-mentioned first and second portions are portions of this chamber. Furthermore, the gas bag can be sealed, wherein e.g. seams and/or material layers of the gas bag at least sectionally can be provided with a sealing coating. Sealing of the gas bag, however, is not absolutely necessary.

For example the lower region of the backrest, from which the inflated gas bag extends to the upper region of the backrest, is formed by a lower half or a lower third of the backrest. It is conceivable that before being inflated, the gas bag at least partly is disposed in the lower half or the lower third of the backrest. It is also possible that a gas generator likewise arranged in the backrest for inflating the gas bag likewise is at least partly arranged in the lower half or in the lower third of the backrest (e.g. at least some outflow openings of the gas generator are disposed in this region of the backrest).

In particular, the gas bag is arranged such and experiences such guidance below the seat cover that it emerges from the upper region of the backrest (i.e. upwards) along a direction extending at least substantially parallel to the backrest; in particular parallel to the main direction of extension of the backrest or parallel to a lateral frame element of a frame of the backrest. The gas bag for example emerges from an upper side of the backrest, i.e. from a portion of the upper region of the backrest, which in the mounted condition of the vehicle seat assembly at least substantially points away from a vehicle floor (and e.g. towards a vehicle roof).

According to another aspect of the invention the seat cover has a weakening in the upper region of the backrest, which tears open under the pressure of the deploying gas bag, so that an opening is obtained through which the gas bag emerges from the backrest. It is conceivable that the weakening is formed by at least one tear seam. For example, the tear seam connects two material blanks of the seat cover.

It is also conceivable that the gas bag is arranged such that it at least sectionally is deployed between a frame of the backrest and the seat cover (in particular between a lateral frame element of the frame and the seat cover). For example, the above-mentioned guidance of the gas bag during its deployment is realized by the seat cover on the one hand and the frame on the other hand. It is also possible that the portion of the gas bag extending under the seat cover in the inflated condition of the gas bag is folded by telescopic folding. Other portions of the gas bag can be folded in some other way, for example by inverted and/or chaotic folding. However, the invention is of course not limited to a particular kind of gas bag folding.

For guiding the deploying gas bag, a guide element different from the seat cover and the backrest frame can be present in addition. For example, the guide element comprises a hollow element arranged under the seat cover (in particular between the seat cover and the backrest frame), in which the gas bag at least partly is deployed. For example, the hollow element is of flexible design, such as in the form of an (e.g. bag-like) envelope (for example in the manner of a softcover).

According to another development of the invention, the gas bag is configured such that in the inflated condition it is supported on a headrest of the vehicle seat. Thus, the portion of the gas bag that has emerged from the vehicle seat at least partly extends at the level of a headrest of the vehicle seat.

It also is conceivable that the portion of the gas bag which after inflation of the gas bag extends through an opening in the seat cover has larger dimensions than a lower portion of the gas bag, which after inflation of the gas bag extends under the seat cover. For example, the portion of the gas bag which extends through the opening in the seat cover has a larger extension in the longitudinal and/or transverse direction of the vehicle than the lower portion of the gas bag.

As already mentioned above, the gas bag also comprises in particular a portion (protective portion) which in the inflated condition of the gas bag outside the vehicle seat is disposed laterally of the head of the vehicle occupant and at the level of the head of the vehicle occupant. As seen in transverse vehicle direction, the gas bag hence at least partly extends beside the head of the vehicle occupant, i.e. the gas bag at least partly is disposed between the head of the vehicle occupant and a vehicle side structure.

It is also conceivable that the gas bag (for example its protective portion) has a portion which in the inflated condition of the gas bag extends in front of a leaning surface of the backrest. With this portion, the gas bag for example can also extend slightly below the head of the vehicle occupant.

According to another aspect of the vehicle seat assembly of the invention, the backrest includes a first and a second lateral region (e.g. in the form of a first and a second side bolster), wherein the first lateral region—based on the condition of the vehicle seat mounted in the vehicle—is closer to a vehicle side structure adjacent to the vehicle seat than the second lateral region, and wherein the gas bag is arranged in the second lateral region of the backrest (e.g. a region facing a further vehicle seat of the vehicle).

In other words, the gas bag here serves as a far-side gas bag that is meant to protect against a collision with a vehicle occupant on an adjacent vehicle seat.

It is also conceivable, however, that the gas bag is arranged on a side of the vehicle seat facing the adjacent vehicle side structure, i.e. as a conventional gas bag for the protection against side collisions. It is of course also possible that the vehicle seat assembly according to the invention comprises two gas bags configured as described above, one of which is arranged on the side facing the vehicle side structure and the other one is arranged on the side of the vehicle seat facing away from the vehicle side structure. For example, these two gas bags are of identical design. However, this is not absolutely necessary. Rather, it is also conceivable that the two gas bags have common features, i.e. at least both extend from the lower region to the upper region of the backrest and emerge from the vehicle seat from the upper region of the backrest, but for example have differently designed protective portions.

The invention also relates to a vehicle with the vehicle seat assembly according to the invention.

### BRIEF DESCRIPTION OF THE DRAWINGS

The invention will be explained in detail below by means of exemplary embodiments with reference to the Figures.

FIG. 1A shows a side view of a vehicle seat assembly according to an exemplary embodiment of the invention prior to an inflation of the gas bag.

FIG. 1B shows the vehicle seat assembly of FIG. 1A during the inflation of the gas bag.

FIG. 1C shows the vehicle seat assembly of FIGS. 1A and 1B with fully inflated gas bag.

FIG. 2 shows a front view of the vehicle seat assembly of FIG. 1C.

FIG. 3 shows a view of the vehicle seat assembly of FIG. 1C from above.

FIG. 4 shows a section through a lateral region of the vehicle seat of a vehicle seat assembly according to the invention.

FIG. 5 shows the section of FIG. 4 during the inflation of the gas bag.

FIG. 6 shows a side view of a vehicle seat assembly according to another exemplary embodiment of the invention.

### DETAILED DESCRIPTION

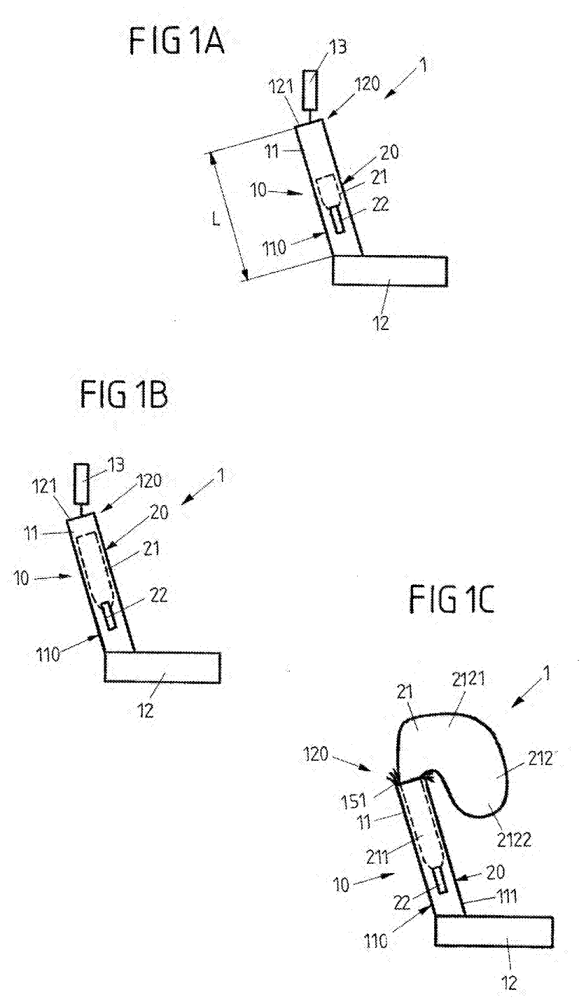

The vehicle seat assembly 1 of the invention as shown in FIG. 1A comprises a vehicle seat 10 with a backrest 11 and a seating surface 12. In a lateral region (such as a side bolster) of the backrest 11 a gas bag module 20 is arranged, wherein the gas bag module 20 comprises a gas bag 21 and a gas generator 22 for inflating the gas bag 21.

The gas bag module 20 is at least partly arranged in a lower region 110 of the backrest 11 such that after activation of the gas generator 22 the gas bag 21 is deployed below a seat cover of the backrest 11 from the lower region 110 to an upper region 120 of the backrest 11. Correspondingly, at least one portion of the gas bag 21 and the gas generator 22 is disposed in the lower region 110. For example, the gas generator 22 and the gas bag 21 each are at least partly arranged in a lower half or a lower third of the backrest 11, i.e. in a region of the backrest 11 that extends from the seating surface 12 of the vehicle seat 10 along half of the length L or along one third of the length L of the backrest 11.

The gas bag 21 thus is deployed out of the lower region 110 up to the upper region 120 below the seat cover (cf. FIG. 1B) and emerges from the backrest 11 only in the upper region 120. More exactly, the pressure of the deploying gas bag 21 produces an opening 151 in the seat cover, through which the gas bag 21 emerges from the backrest 11. It is conceivable that the opening 151 is obtained by a tear seam tearing open, which e.g. connects a side part and an upper part of the seat cover. The deploying gas bag 21 in particular is guided through the seat cover and a lateral frame element of a frame (not shown) of the backrest 11 such that it emerges from the backrest 11 at least approximately parallel to the frame and hence parallel to the backrest 11 in upward direction (away from the seating surface 12).

In the inflated condition of the gas bag 21 shown in FIG. 1C, an oblong first portion 211 of the gas bag 21, which extends from the lower region 110 to the upper region 120 (as far as the upper side 121) of the backrest 11 and parallel to the lateral seat frame part, below the seat cover, while a second portion in the form of a protective portion 212 extends outside the backrest 11.

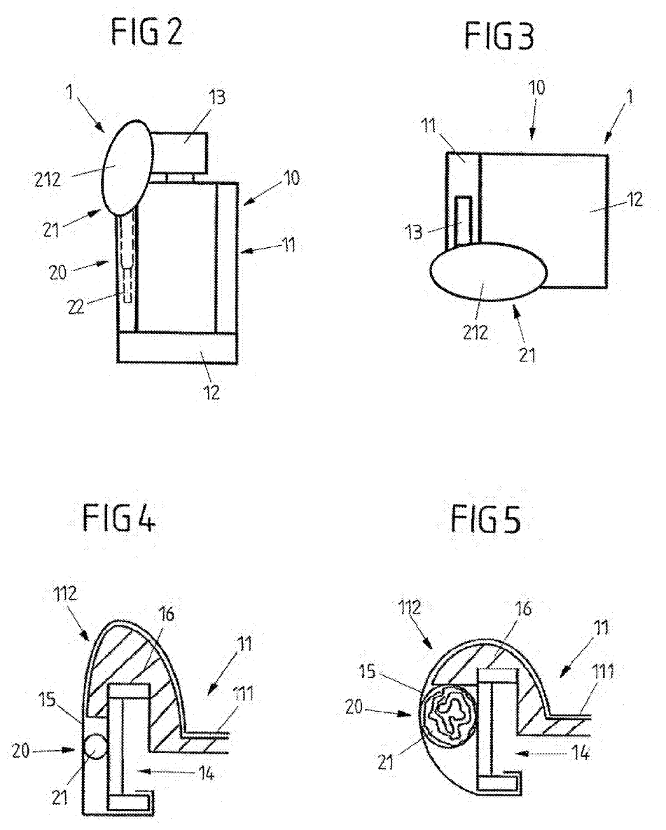

The protective portion 212 is shaped such that it extends laterally beside the head of a vehicle occupant (not shown) on the vehicle seat 10; cf. the front view of FIG. 2. For example, the protective portion 212 of the gas bag 21 has an upper region 2121 that is disposed at the level of a headrest 13 of the vehicle seat 10 and for example is supported on the same. A lower region 2122 of the protective portion 212 of the gas bag 21 for example extends (as seen in direction of forward travel) in front of a leaning surface 111 of the backrest 11.

FIG. 4 shows a sectional view of a side bolster 112 of the vehicle seat 10 of a vehicle seat assembly according to the invention. For example, FIG. 4 corresponds to a section through the vehicle seat 10 shown in FIG. 1A. The gas bag module 20 with the gas generator and the gas bag 21 arranged above the same is disposed in the side bolster 112, wherein the gas bag module 20 is arranged between a lateral frame element 14 of a frame of the backrest 11 of the vehicle seat and a seat cover 15 of the backrest 11. The backrest 11 in addition includes a padding 16 which in particular extends in a front region of the backrest 11 (and for example with one portion also is disposed in front of the gas bag module 20). FIG. 5 shows the section of FIG. 4 during the deployment of the gas bag 21.

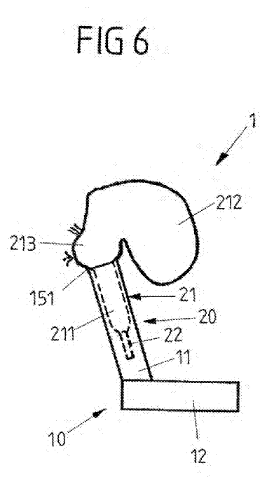

FIG. 6 shows a modification of the vehicle seat assembly of FIGS. 1A to 3. Accordingly, the gas bag 21 includes a portion 213 disposed between its lower portion 211 and the protective portion 212, with which the gas bag 21 extends through the opening 151 in the seat cover out of the backrest 11 to the outside. The portion 213 has larger dimensions than the lower portion 211 in order to provide for a reproducible generation of the opening 151 as completely as possible in the seat cover (for example the tearing open of the tear seam). In particular, the portion 213 has a larger thickness than the lower portion 211 as seen in the longitudinal and transverse directions of the vehicle.

1. A vehicle seat assembly for a motor vehicle, comprising
a vehicle seat; and
at least one inflatable gas bag arranged in a backrest of the vehicle seat for the protection of at least the head of a vehicle occupant on the vehicle seat,
wherein the gas bag is arranged and configured in such a way that in the inflated state it extends under a seat cover of the vehicle seat from a lower region of the backrest to an upper region of the backrest and emerges from the vehicle seat in the upper region of the backrest.

2. The vehicle seat assembly according to claim 1, wherein the lower region of the backrest is formed by a lower half or a lower third of the backrest.

3. The vehicle seat assembly according to claim 1, wherein the gas bag emerges from the upper region of the backrest along a direction extending at least substantially parallel to the backrest.

4. The vehicle seat assembly according to claim 1, wherein the gas bag extends from the lower region to the upper region of the backrest exclusively below the seat cover.

5. The vehicle seat assembly according to claim 1, wherein in the upper region of the backrest the seat cover has a weakening that tears open under the pressure of the deploying gas bag, so that an opening is obtained through which the gas bag emerges from the backrest.

6. The vehicle seat assembly according to claim 5, wherein the weakening is formed by at least one tear seam.

7. The vehicle seat assembly according to claim 1, wherein the gas bag is arranged such that it at least sectionally is deployed between a frame of the backrest and the seat cover.

8. The vehicle seat assembly according to claim 1, wherein at least one portion of the gas bag extending under the seat cover in the inflated condition of the gas bag is folded by telescopic folding.

9. The vehicle seat assembly according to claim 1, further comprising a guide element for guiding the deploying gas bag.

10. The vehicle seat assembly according to claim 9, wherein the guide element is formed by a flexible hollow element arranged under the seat cover, in which the gas bag is at least partly deployed.

11. The vehicle seat assembly according to claim 1, wherein the gas bag is configured such that in the inflated condition it is supported on a headrest of the vehicle seat.

12. The vehicle seat assembly according to claim 1, wherein the portion of the gas bag which after inflation of the gas bag extends through an opening in the seat cover has larger dimensions than a lower portion of the gas bag, which after inflation of the gas bag extends under the seat cover.

13. The vehicle seat assembly according to claim 1, wherein the gas bag includes a portion which in the inflated condition of the gas bag at least partly is disposed laterally of the head of the vehicle occupant and at the level of the head of the vehicle occupant.

14. The vehicle seat assembly according to claim 1, wherein the gas bag includes a portion which in the inflated condition of the gas bag extends in front of a leaning surface of the backrest.

15. The vehicle seat assembly according to claim 1, wherein the backrest includes a first and a second lateral region, wherein the first lateral region—based on the condition of the vehicle seat mounted in the vehicle—is closer to a vehicle side structure adjacent to the vehicle seat than the second lateral region, and wherein the gas bag is arranged in the second lateral region of the backrest.
